(19) United States
(12) Patent Application Publication
(10) Pub. No.: US 2005/0021385 A1
(43) Pub. Date: Jan. 27, 2005

(54) Consulting service system for internet

(76) Inventor: Shu-Fen Lin, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/623,697

(22) Filed: Jul. 22, 2003

(51) Int. Cl. G06F 17/60

(52) U.S. Cl. 705/10; 705/1; 705/9

(57) ABSTRACT

A consulting service system for Internet includes an ask zone in which an asker can ask a new question, appoint a suitable answerer and get an enter certificate for the asker to entering a searching procedure and a re-asking procedure. An answer zone communicates with the ask zone. The consulting service system requests and confirms the username of the answerer for allowing the answerer entering the answer zone and answering the questions in the answer zone. The answerer inputs a sum of money about answering the question when the answering procedure needs a service charge. A data process zone communicates with the ask zone and the answer zone. The data process zone is provided to save and order the data about the asker and the answerer.

### BACKGROUND OF THE INVENTION

1. Field of the Invention

The present invention relates to a consulting service system, and more particularly to a consulting service system for Internet.

2. Description of Related Art

The conventional consulting service system for Internet generally comprises the types, such as e-mail, Bulletin Board System (BBS) and live talk.

In e-mail type: The asker must deliver the question to the mailbox of the answerer by e-mail. The answerer processes the data from the asker after receiving the e-mail and answers the asker by e-mail. By this type, the asker may get a complete reply to the question, meet an answerer who is skilled in the art of the question or get a reply from another answerer who gets the question from the original answerer. However, the prerequisite for the asker to get a satisfied answer is to meet a right answerer. The great problem of this type is the probability of meeting a right answerer is low such that the asker may get an answer that does not conform to the asker.

In BBS type: The member can arbitrarily enter all the classified discuss zone of the website where the member has been registered. In the mean time, the member can ask question and answer the question from other members. The question from the asker can be answered in time by all the members who are online. Afterward, the question and the answer of the question are proclaimed on the discuss zone of the website. However, all the online members, who may not be professional, can answer all the questions such that the answer may not be specialized enough for satisfying the asker. Furthermore, too many answers may make the asker confused and BBS cannot provide good secrets to the user because the question and the answer are proclaimed after answering.

In live talk type: This type shortens the process time of asking and answering, but retains all the disadvantages of BBS type. Furthermore, the user is hard to get a professional answer in a live chat room.

The present invention has arisen to mitigate and/or obviate the disadvantages of the conventional types of consulting service system for Internet.

### SUMMARY OF THE INVENTION

The main objective of the present invention is to provide an improved consulting service system for Internet.

To achieve the objective, the consulting service system in accordance with the present invention comprises an ask zone in which an asker can ask a new question, appoint a suitable answerer and get an enter certificate for the asker to entering a searching procedure and a re-asking procedure. An answer zone communicates with the ask zone. The consulting service system requests and confirms the certificate of the answerer for allowing the answerer entering the answer zone and answering the questions in the answer zone. The answerer inputs a service charge about answering the question when the answering procedure needs a service charge. A data process zone communicates with the ask zone and the answer zone. The data process zone is provided to save and order the data about the asker and the answerer.

Further benefits and advantages of the present invention will become apparent after a careful reading of the detailed description with appropriate reference to the accompanying drawings.

### BRIEF DESCRIPTION OF THE DRAWINGS

FIG. 1 illustrates a server in accordance with the present invention;

FIG. 2 illustrates processing steps associated with the consulting service system in accordance with the present invention when the user brings a new question into the system;

FIG. 3 illustrates processing steps associated with the consulting service system in accordance with the present invention when the user executes the searching and re-ask procedures;

FIG. 4 illustrates processing steps associated with the consulting service system in accordance with the present invention when the answerer executes the searching and answering procedures;

FIG. 5 illustrates a page of the consulting service system of the present invention for user to ask a new question;

FIG. 6 illustrates a page of the answerer introduce zone of the present invention;

FIG. 7 illustrates a page of the consulting service system of the present invention for saving procedure;

FIG. 8 illustrates a page of the consulting service system of the present invention when the answerer orders all the questions during searching procedure;

FIG. 9 illustrates a page of the consulting service system of the present invention for showing the asker and the questions that answerer needs to answer; and

FIG. 10 illustrates a page of the consulting service system of the present invention when the asker orders all the questions that he/she has asked.

### DETAILED DESCRIPTION OF THE INVENTION

The consulting service system for Internet in accordance with the present invention is to provide an interactive dialogue service site for askers and answerers communicating with one another via an explorer.

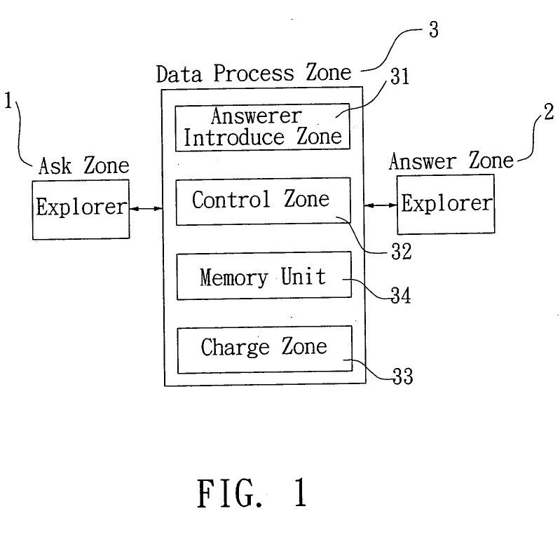

With reference to FIG. 1, the consulting service system for Internet in accordance with the present invention comprises multiple ask zone (1), multiple answer zone (2) and a data process zone (3) communicating with one another. The data process zone (3) includes an answerer introduce zone (31), a control zone (32) and a charge zone (33).

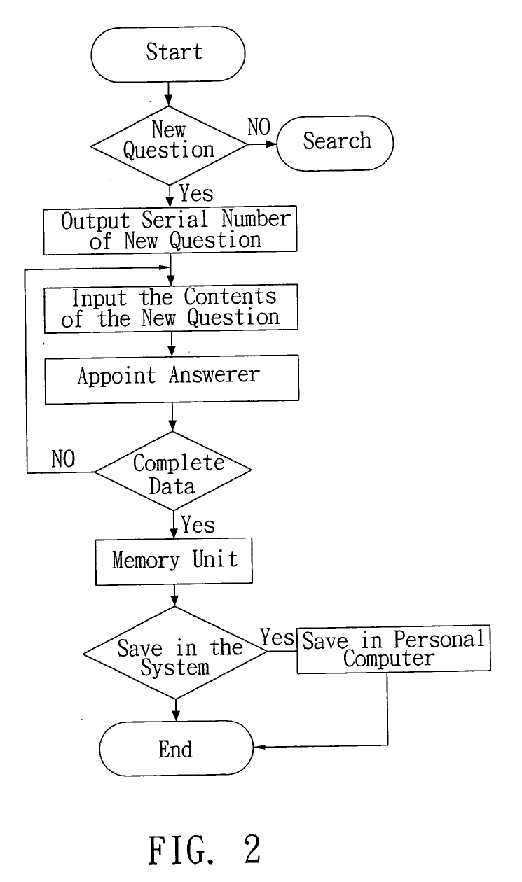

With reference to FIG. 2, in the ask zone (1) the asker can ask a new question or search the question that he/she has asked.

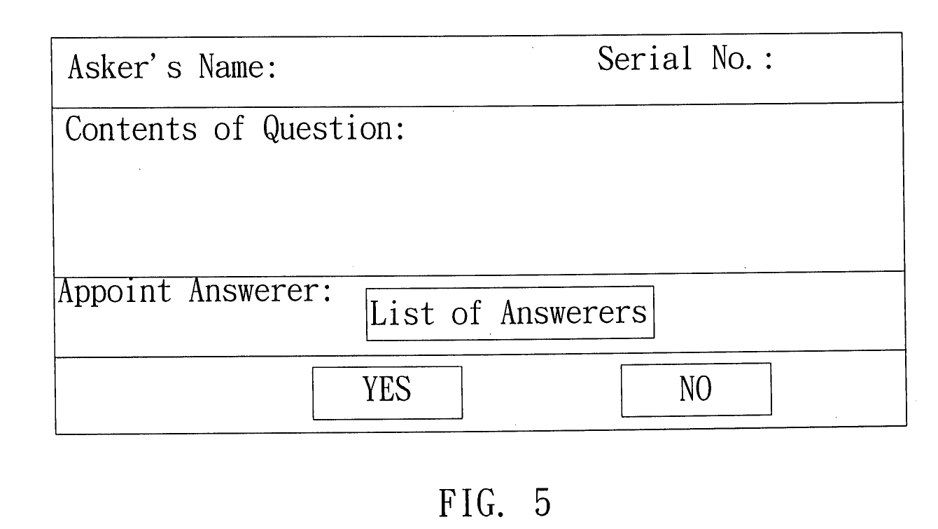

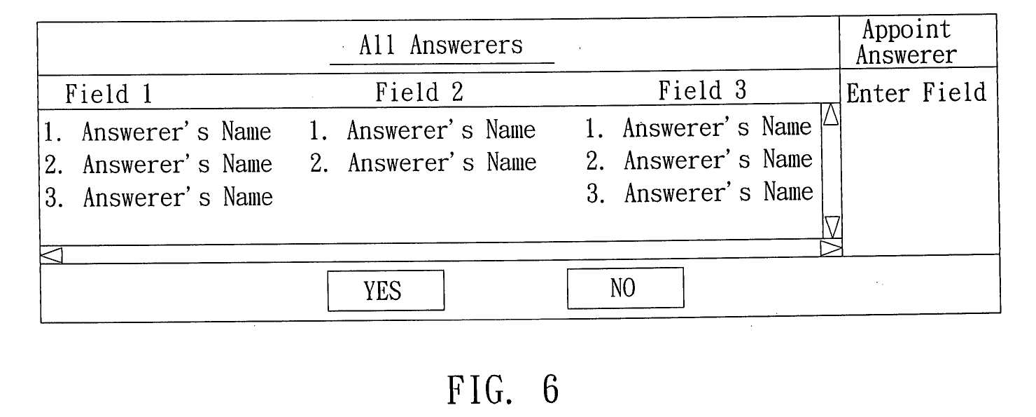

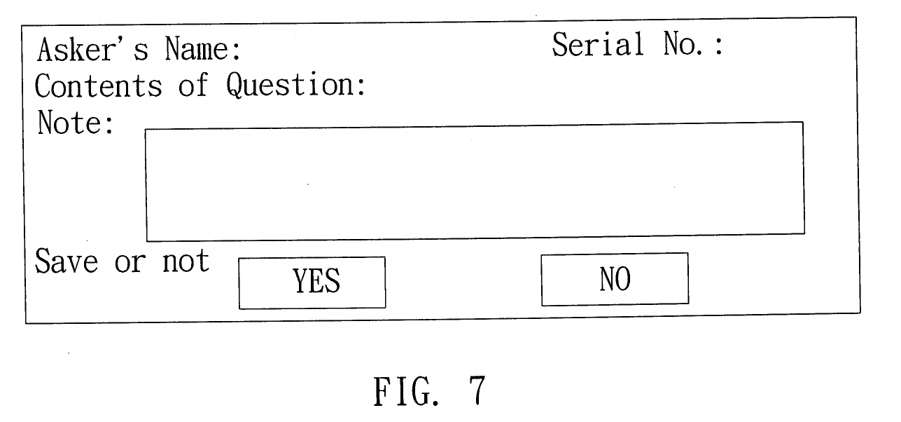

When asking a new question, further with reference to FIG. 5, the consulting service system of the present invention provides a new serial number for the new question and requests the asker to input the usemame and the subject matter of the new question that will be used as an enter certificate when the asker want to enter the searching procedure. The page, as shown in FIG. 6, is displayed when the asker clicks the button of LIST OF ANSWERERS. The data of the answerers, shown in the page of FIG. 6, in addition to the names of the answerers, includes the background of the answerers such that the asker can refer to the above data of the answerers and appoint one or more answerers of different fields to answer the question(s) that the asker has asked. With reference to FIG. 7, the asker can save the data concerning the question(s) in a memory zone (34) in the data process zone (3) or in a personal computer of the asker. This procedure is ended when finishing saving data or the asker clicking the button of NO in the page as shown in FIG. 7.

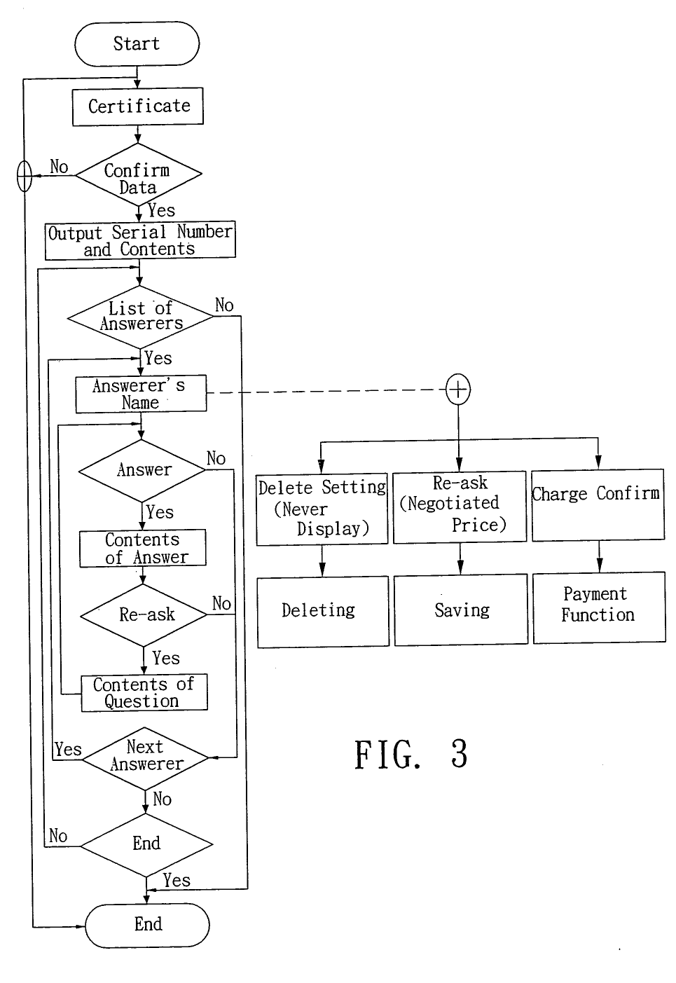

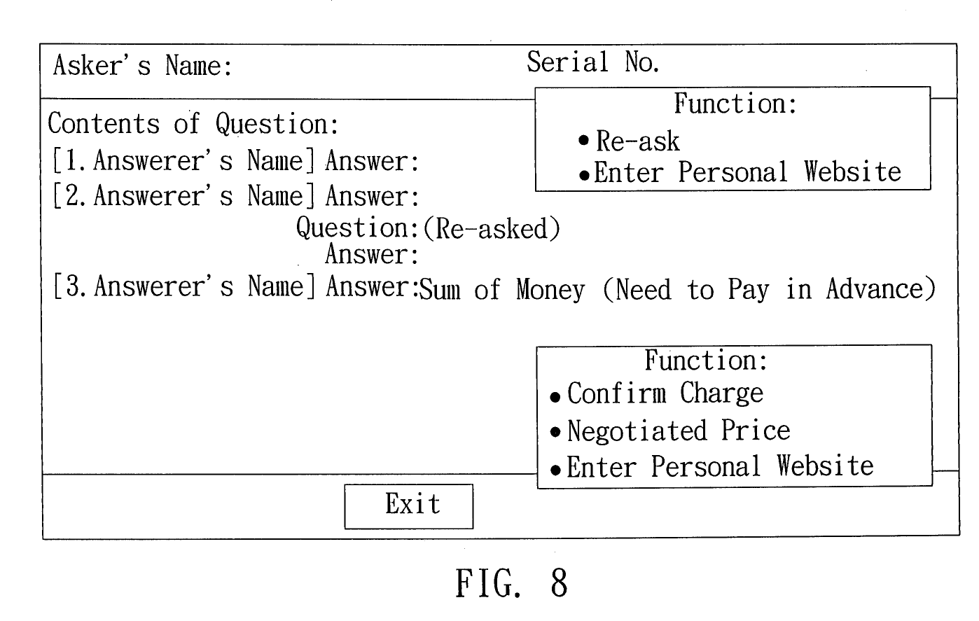

With reference to FIG. 3, the user is requested to input the usemame, the serial number of the question that the user wants to search and the inputted data needs to be confirmed for asserting the secrets of the user. After confirming the personal data that the user has inputted, a page is displayed, as shown in FIG. 8, and then a list of answerers and answers is shown on this page that shows the not-deleted question(s) and the answered question(s) for user to browse, deleting unnecessary answer(s), re-ask relative to the answer and the answer or select others answerers for the question or further ask for a charged consulting.

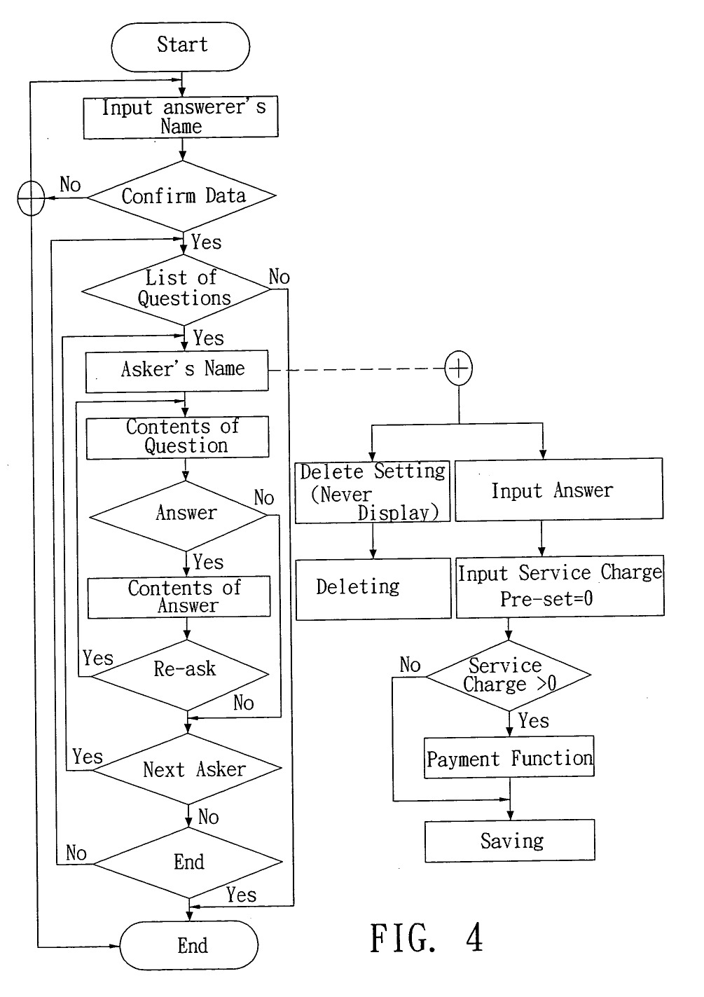

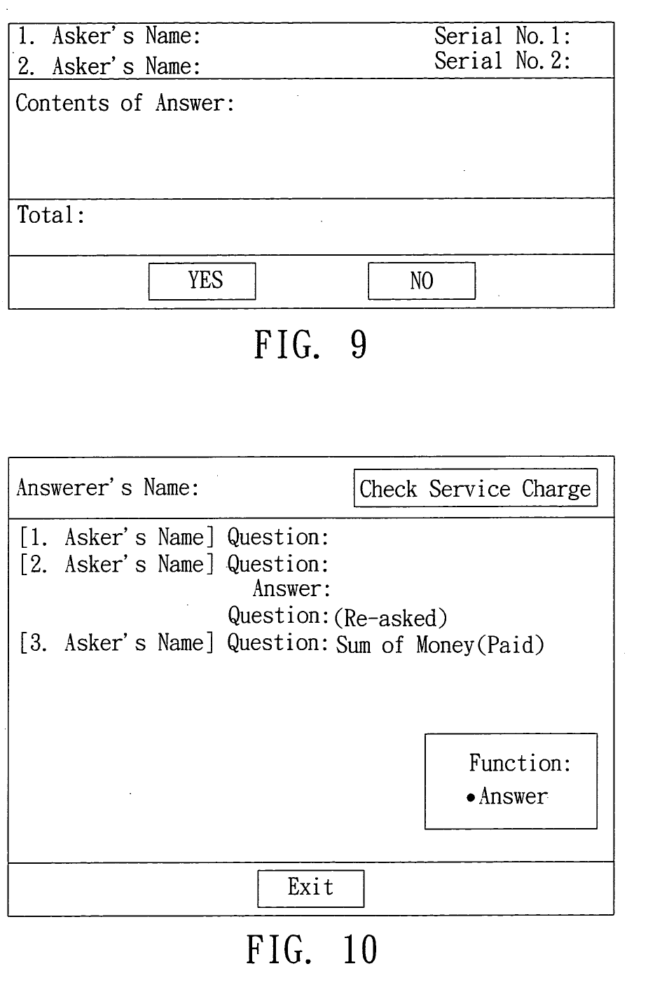

With reference to FIG. 4, the answerer needs to input his/her certificate when entering the answer zone (2). Further with reference to FIG. 10, a list of questions is displayed on the page as shown in FIG. 10 after confirming the input data from the answerer. Then the answerer can arrange data shown on the page and delete the question that the answerer does not want to answer. With reference to FIG. 4 and 9, the answerer can answer the question one by one or select the same questions from different askers and answer at a time. The answerer inputs the service charge about answering the question and save the concerning data when the answering procedure needs a service charge. When the finishing answering a question, the answerer may enter the answer page for next question. The answering procedure is ended when the answerer finishes answering the question that he/she has selected.

With regard to the data process zone (3), in the answerer introduce zone (31), the asker can browse all the personal data of the answerers as the reference for selecting a suitable answerer such that the asker can receive an accurate answer. In the control zone (32), the excellent answerer is encouraged and the bad answerer is fired via the interactive data between the askers and the answerers. Consequently, the service standard and the competition of the answerers are promoted such that the consulting service of the present invention can provides a better consulting service. In the charge zone, the business transactions of knowledge are more unobstructed via an Internet e-wallet.

Furthermore, in the consulting service system of the present invention, a membership is unnecessary such that the answerer cannot be aware of the data of the asker besides data about the contents of the question. Consequently, the consulting service system for Internet in accordance with the present invention can provide a good protection to the secret of the askers.

Although the invention has been explained in relation to its preferred embodiment, it is to be understood that many other possible modifications and variations can be made without departing from the spirit and scope of the invention as hereinafter claimed.

1. A consulting service system for Internet, comprising:
an ask zone, in which an asker can ask a new question, appoint a suitable answerer and get an enter certificate for the asker to entering a searching procedure and a re-asking procedure;
an answer zone communicating with the ask zone, the consulting service system requesting and confirming the certificate of the answerer for allowing the answerer entering the answer zone and answering the questions in the answer zone, the answerer inputting a service charge about answering the question when the answering procedure needs a service charge; and
a data process zone communicating with the ask zone and the answer zone, the data process zone provided to save and order the data about the asker and the answerer.

2. The consulting service system as claimed in claim 1, wherein the data process zone comprises:
an answerer introduce zone for asker to browse the data of the answerer as the reference for selecting a suitable answerer;
a control zone for the consulting service system to appraise the answerers via the interactive data between the askers and the answerers; and
a charge zone making the business transactions of knowledge more unobstructed via an Internet e-wallet.

3. The consulting service system as claimed in claim 1, wherein:
the asking zone provides a new serial number and requests the asker to input the usemame and the serial number of the new question when asker asks a new question, the inputted usemame and the serial number of the new question used as an enter certificate when the asker wants to enter the searching procedure;
the data of the answerers is shown when the asker clicks a button of LIST OF ANSWERERS such that the asker can refer to the data of the answerers and appoint at least one answerer of different field to answer the question that the asker has asked;
the asker can save the data concerning the question(s) in a memory zone in the data process zone and end the asking procedure.

4. The consulting service system as claimed in claim 1, wherein the user is requested to input the usemame, the serial number of the question that the user wants to search and the inputted data needs to be confirmed for asserting the secrets of the user, after confirming the personal data that the user has inputted, a page showing a list of answerers and answers for user to browse, delete unnecessary answer(s), re-ask relative to the answer or select others answerers for the question or further ask for a charged consulting.

5. The consulting service system as claimed in claim 1, wherein the answerer needs to input his/her certificate when entering the answer zone, a list of questions displayed after confirming the input data from the answerer, the answerer arranging shown data and deleting the question that he/she does not want to answer, the answerer answering the question one by one or selecting the same questions from different askers and answering at a time, the answerer inputting the service charge about answering the question and saving the concerning data when the answering procedure needs a service charge.

6. The consulting service system as claimed in claim 2, wherein data about the answerers shown in the answerer introduce zone includes name and the background of the answerers for user to refer and appoint at least one suitable answer.
